(19) United States
(12) Patent Application Publication
(10) Pub. No.: US 2012/0228299 A1
(43) Pub. Date: Sep. 13, 2012

(54) CONTAINER LID

(76) Inventors: Andrew Folos, Malvern East (AU); Aristomenis Argyropoulos, Dingley Village (AU)

(21) Appl. No.: 13/503,082

(22) PCT Filed: Oct. 19, 2010
(86) PCT No.: PCT/AU2010/001389

§ 371 Date: Apr. 20, 2012

(30) Foreign Application Priority Data
Oct. 20, 2009 (AU) 2009905114

(51) Int. Cl. B65D 51/16; B29C 59/02; B29C 51/10; B65D 43/00

(52) U.S. Cl. 220/367.1; 220/377; 264/320; 264/571

(57) ABSTRACT

A lid (100,200) for a container (12) including at least one transparent section to enable the contents of the container (14) to be viewed or partially viewed when the lid (100,200) is fitted to the container (12). At least part of the at least one transparent section being constructed of an anti-fog material, or being coated with an anti-fog material, to prevent or reduce build up of condensation on an inner surface of the lid (100,200) during use.

### CROSS-REFERENCE TO RELATED APPLICATIONS

This application is the U.S. national phase of PCT/AU2010/001389, filed Oct. 19, 2010, which claims priority to Australia Provisional Patent Application No. 2009905114, filed Oct. 20, 2009, the disclosures of each of which are incorporated herein by reference in their entirety.

### FIELD OF THE INVENTION

The present invention relates generally, to lids for food and beverage containers, and relates particularly, though not exclusively, to lids for hot beverage containers or cups.

It will be convenient to hereinafter describe the invention in relation to lids for hot beverage cups, however it should be appreciated that the present invention is not limited to that use only. The lid of the present invention may also be used for cold beverage containers or cups, or hot/cold food containers, without departing from the spirit and scope of the invention as hereinafter described. Accordingly, throughout the ensuing description the expressions “container” or “cup” are simply intended to refer to any suitable vessel for which food or beverage products may be supplied, and to which a lid made in accordance with the invention may be applied thereto.

### BACKGROUND

Any discussion of documents, devices, acts or knowledge in this specification is included to explain the context of the invention. It should not be taken as an admission that any of the material forms a part of the prior art base or the common general knowledge in the relevant art in Australia or elsewhere on or before the priority date of the disclosure and broad consistory statements herein.

Beverage products are commonly supplied for consumption in disposable cups. These cups are generally provided with a lid to prevent spillage. When used for hot beverages, lids also act to maintain the temperature of the beverage product for a period of time.

Some lids include drinking nozzles or spouts that enable a beverage to be consumed without having to remove the lid from a cup. Other lids sometimes include handy stackable features to enable consumers to stack cups one on top of another to assist with transporting multiple cups from a point of sale to, for example, an office or car.

One of the most common hot beverages supplied in disposable cups is coffee. Coffee is available in many different forms depending on consumer preference. The most popular styles in Australia include Café Latte, Cappuccino, Flat White, and Short/Long Black (espresso). Of these popular styles, all except the “Black” coffees are made with steamed milk. In the case of Café Latte's and Cappuccino's, in addition to the steamed milk these coffees are also topped with varying levels of foamed milk.

In recent times it has become increasing popular for baristas to decorate the top of milk-based hot beverages, including coffee. The most common decorations include shapes formed on/in the foamed milk portion of the beverage. These decorations are seen as a means of enhancing a consumers drinking experience.

When sitting down at a café or restaurant to enjoy a coffee prepared in a (non-disposable) coffee cup or mug, the aesthetic aspects of a decorated coffee can be readily experienced. However, when purchasing a coffee in take away form, this aesthetic experience can be spoilt by the application of a lid to a disposable coffee cup. This is because conventional disposable coffee cup lids are opaque, and hence, when applied to a cup the decorative features of the coffee are no longer visible. Of course a lid can be readily removed to once again expose those decorative features, however in most cases the initial application of the lid may have damaged or ruined the decoration(s).

Accordingly, a need exists for an improved lid for a hot beverage container or cup, one that will enable consumers to enjoy the visual aspects of decorated beverages in take away form.

### SUMMARY OF THE INVENTION

According to one aspect of the present invention there is provided a lid for a container, said lid including at least one transparent section to enable the contents of said container to be viewed or partially viewed when said lid is fitted to said container, wherein at least part of said at least one transparent section is constructed of an anti-fog material, or is coated with an anti-fog material, to prevent or reduce build up of condensation on an inner surface of said lid during use.

Preferably said container is a disposable cup for supplying hot beverages including, but not limited to, coffee, hot chocolate, tea, and/or soup.

In a practical preferred embodiment said lid includes one transparent viewing window disposed on an upper surface thereof that corresponds to a substantial portion of the exposed surface of said hot beverage within said cup such that any visually pleasing aspects of said hot beverage are viewable through said window. Preferably said window is constructed of said anti-fog material, or at least a substantial portion of said window is coated with said anti-fog material.

In an alternative practical preferred embodiment said lid is completely transparent, and is at least partially constructed of said anti-fog material or is at least partially coated with said anti-fog material.

Preferred transparent materials that may be used to construct said lid, or parts of said lid, include, but are not limited to, food grade versions of: PET, PET-A, PET-G, PC, Polyurethane, Polyvinylchloride and Polystyrene. In a practical embodiment, for coffee applications it is preferred that said lid is constructed of PET-G and/or Styrene.

Preferred anti-fog coatings include, but are not limited to, surfactants coatings, hydrophilic coatings, hydrophilic colloids and nanoparticles. Preferred brands include, but are not limited to: SciCron Technologies AF-01 (AF-100™) Permanent Anti-Fog Coating and Hydromer Anti-Fog Coating 2009-68-2.

Preferably said lid further includes: at least one dispensing nozzle or spout; and/or, at least one vent or hole to assist with the anti-fog properties of said lid and/or to allow the aroma of said hot beverage to escape into the surrounding area proximate said cup.

It is also preferred that said lid is of the stackable type to aid with the transportation of multiple like cups stacked one on top of another.

Preferably said lid comprises a domed portion for reducing or eliminating the build up of condensation on an inner surface of said lid during use. Said domed portion may be convex or concave.

According to a further aspect of the present invention there is provided a method of manufacture of a lid for container, said method including the steps of: producing a lid having at least one transparent section that enables the contents of said container to be viewed or partially viewed when said lid is fitted to said container; and, applying an anti-fog coating to at least part of said at least one transparent section to prevent build up of condensation on an inner surface of said lid during use.

Preferably said step of producing said lid includes vacuum forming of said lid from thin sheet/film suitable materials.

Preferably said lid is for a disposable cup for supplying hot beverages including, but not limited to, coffee, hot chocolate, tea, and/or soup.

Yet a further broad form of the invention that may be preferred provides use of the lid as described with reference to any one of the preceding paragraphs, for the supply of hot beverages including, but not limited to, coffee, hot chocolate, tea and/or soup.

These and other essential or preferred features of the present invention will be apparent from the description that now follows.

### BRIEF DESCRIPTION OF THE DRAWINGS

In order that the invention may be more clearly understood and put into practical effect there shall now be described in detail preferred constructions of a beverage container lid in accordance with the invention. The ensuing description is given by way of non-limitative example only and is with reference to the accompanying drawing, wherein:

FIG. 1 is a perspective view illustrating the application, in stages, of a prior art opaque lid to a disposable cup of decorated coffee;

FIG. 2 is a perspective view illustrating the application, again in stages, of a transparent lid made in accordance with a first preferred embodiment of the present invention to the same disposable cup of decorated coffee shown in FIG. 1; and,

FIGS. 3a to 3l are perspective views of alternative transparent or partially transparent lids made in accordance with further preferred embodiments of the present invention.

### DETAILED DESCRIPTION

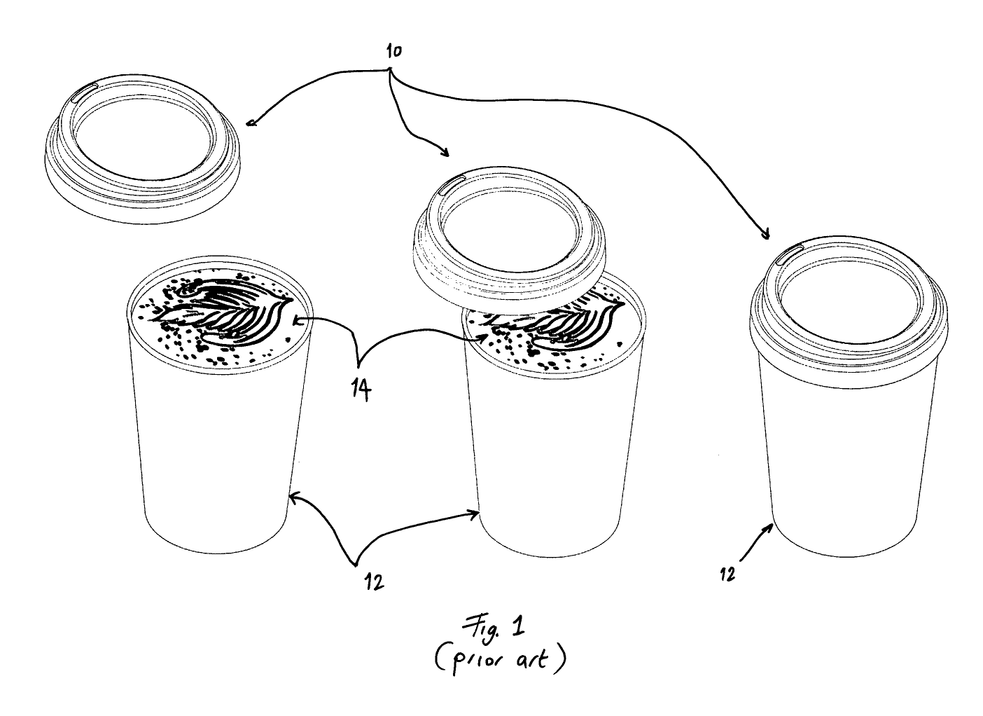

FIG. 1 illustrates the application, in stages, of a prior art opaque beverage cup lid 10 (hereinafter “opaque lid 10”) to a decorated cup of coffee 12 (or similar beverage, including, but not limited to, hot chocolate, tea and/or soup). Here it can be seen that when opaque lid 10 is applied to cup 12 the decorative features 14 of the coffee are lost (i.e. hidden), as the opaque properties of lid 10 do not allow the decorative features 14 of the coffee to be viewed through lid 10.

FIG. 2 illustrates the application, again in stages, of a beverage cup lid 100 (hereinafter “lid 100”) made in accordance with a preferred embodiment of the present invention to the same decorated cup of coffee 12 shown in FIG. 1. Here, unlike in the case of opaque lid 10, it can be seen that when lid 100 is applied to cup 12 the decorative features 14 of the coffee are still viewable through lid 100.

As is shown in FIG. 2, to enable the decorative features 14 of the coffee to be viewed through lid 100, lid 100 may be entirely transparent, or may be provided with at least one viewing window (not shown). Ideally, a suitable viewing window would be disposed on the upper surface of lid 100, such that it would correspond to a substantial portion of the exposed surface of the coffee relative to decorative features 14. In this way, the visually pleasing aspects (decorative features 14) of the coffee would be viewable through the window.

In order to ensure that the entire transparent lid 100, or the transparent viewing window thereof (not shown), are not obstructed by condensation or the likes during use, at least parts of lid 100 (or the viewing window) are constructed of an anti-fog material, or are coated with an anti-fog material. In the case of an anti-fog coating, same only needs to be applied to the inner surface of lid 100 to assist with the prevention (or reduction) of the build up of condensation.

Suitable transparent materials that may be used to construct lid 100, or parts of lid 100, include food grade versions of: PET, PET-A, PET-G, PC, Polyurethane, Polyvinylchloride and Polystyrene. It has been found that for coffee applications, PET-G and Styrene are very well suited.

Suitable anti-fog coatings include: surfactants coatings, hydrophilic coatings, hydrophilic colloids and nanoparticles. It has been found that SciCron Technologies AF-01 (AF-100™) Permanent Anti-Fog Coating and Hydromer Anti-Fog Coating 2009-68-2 are very well suited for coffee applications. These coatings cause moisture from the air to spread in an even film over the inner surface of lid 100 without forming droplets. Consequently, that surface remains free of fog, even under the very humid conditions within cup 12 which would normally cause fogging of that surface.

Such anti-fog materials/coatings eliminate/drastically reduce the build up of water droplets by minimising surface tension, resulting in a non-scattering film of water, an effect commonly referred to as ‘wetting’.

In terms of the application of such suitable anti-fog coatings to lid 100, same is ideally done after lid 100 is vacuum formed from suitable thin sheet/film materials, but may be applied to the sheet/film materials before lid 100 is vacuum formed. A person skilled in the art will appreciate such variations in available manufacturing processes.

Aside from having the aforementioned transparent and anti-fog features/properties, lid 100 may also include other features to ensure that visually pleasing aspects (decorative features 14) of the coffee are always viewable and/or to improve the functionality/usability of lid 100. For example, in FIG. 2 it can be seen that lid 100 may be of the stackable type and may also include a drinking nozzle or spout 16.

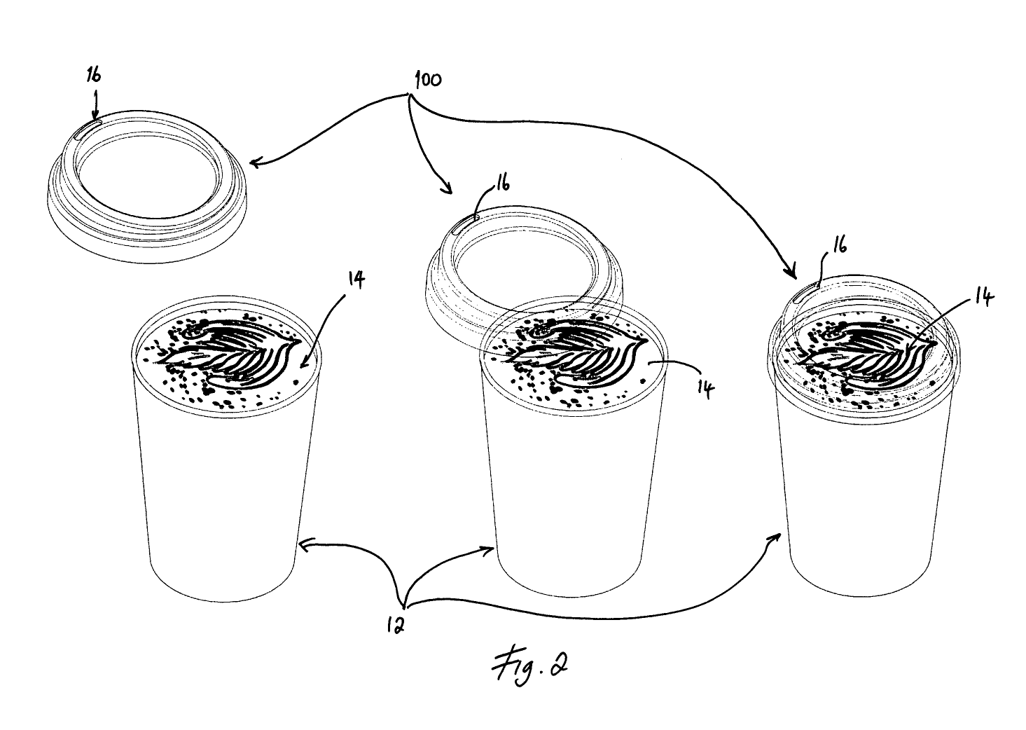

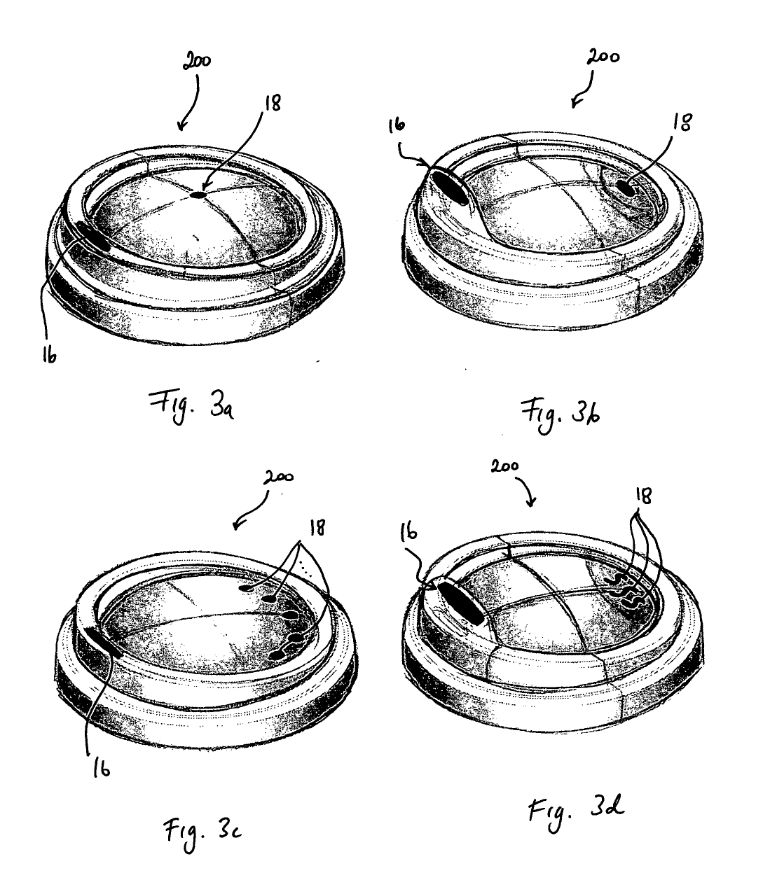

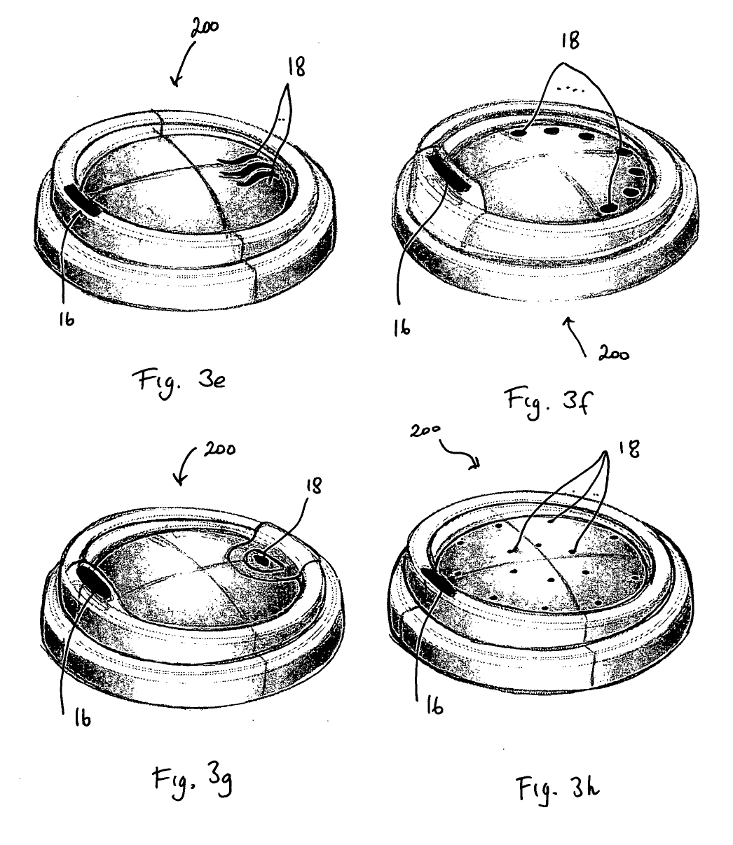

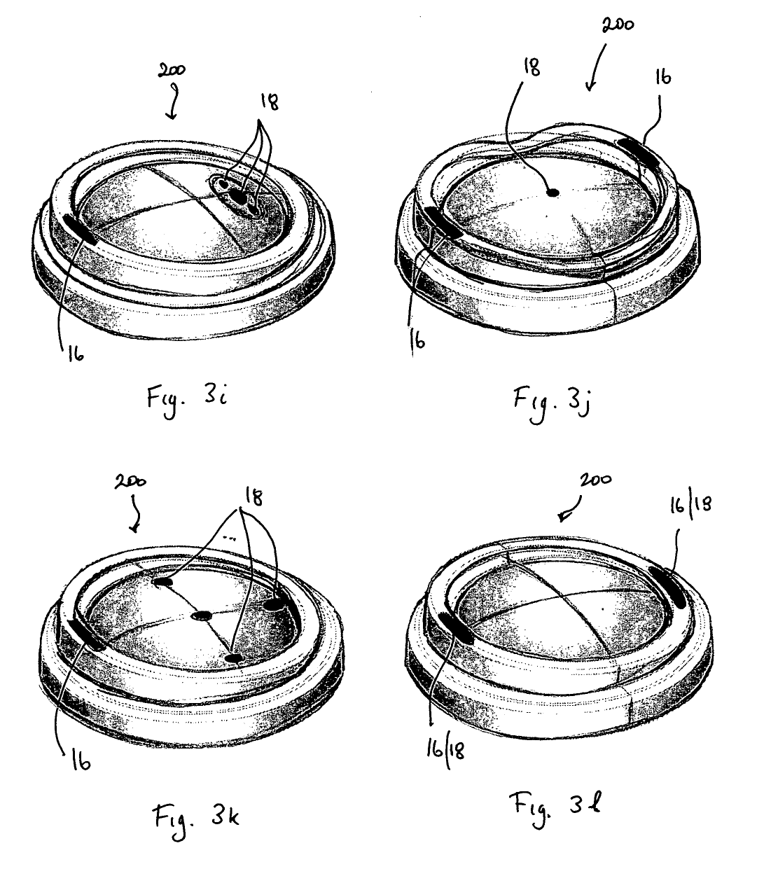

In FIGS. 3a to 3l there is shown many alternative transparent (or partially transparent) and anti-fog lids 200 made in accordance with further preferred embodiments of the present invention.

It can be seen in these figures that each of these lids 200 may include at least one drinking nozzle 16, at least one vent or hole 18 to assist with the anti-fog properties of lid 200 and/or to allow the aroma of the coffee to escape into the surrounding area proximate cup 12, and may be of the stackable type.

Another design feature that is common to lids 200 of FIGS. 3a to 3l is the inclusion of a domed convex upper surface (or inverted domed concave upper surface—not shown). Such a domed concave/convex surface assists with the elimination or reduction of condensation by encouraging water droplets to either move toward the outer edges of the inner surface of lids 200 (convex), or to drop away from lid 200 back into cup 12 (concave). A person skilled in the art will appreciate many suitable ways in which such lids 200 can be designed in order to enable like cups 12 to be stacked on lids 200. For this reason a detailed discussion of the stackable nature of lids 200 will not be provided in this description. It should be appreciated that the addition of nozzles 16 and the stackable properties of lids 200 are not essential features of the invention as herein defined. Likewise, although vents/holes are proposed to, for example, assist with ensuring that lids 200 do not fog up during use, same are only provided to assist with the anti-fog materials or coatings of lids 200. Finally, a person skilled in the art will appreciate other design aspects or features that could be included on lids 200 to improve their operation and/or usability. Accordingly the present invention should not be construed as limited to the specific examples provided.

The present invention therefore provides an improved lid for a beverage container or cup that overcomes or alleviates one or more of the problems outlined at the outset of this description.

While this invention has been described in connection with specific embodiments thereof, it will be understood that it is capable of further modification(s). The present invention is intended to cover any variations, uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. Various modifications and equivalent arrangements are intended to be included within the spirit and scope of the invention as described herein and as claimed in the appended claims. Therefore, the specific embodiments are to be understood to be illustrative of the many ways in which the principles of the present invention may be practiced.

Where the terms “comprise”, “comprises”, “comprised” or “comprising” are used in this specification, they are to be interpreted as specifying the presence of the stated features, integers, steps or components referred to, but not to preclude the presence or addition of one or more other features, integers, steps, components to be grouped therewith.

1. A lid for a container, said lid including at least one transparent section to enable the contents of said container to be viewed or partially viewed when said lid is fitted to said container, wherein at least part of said at least one transparent section is constructed of an anti-fog material, or is coated with an anti-fog material, to prevent or reduce build up of condensation on an inner surface of said lid during use.

2. The lid for a container as claimed in claim 1, wherein said container is a disposable cup for supplying a hot beverage selected from the group consisting of: coffee, hot chocolate, tea, and, soup.

3. The lid for a container as claimed in claim 2, wherein said lid includes one transparent viewing window disposed on an upper surface thereof that corresponds to a substantial portion of the exposed surface of said hot beverage within said cup such that any visually pleasing aspects of said hot beverage are viewable through said transparent viewing window.

4. The lid for a container as claimed in claim 4, wherein said transparent viewing window is constructed of said anti-fog material, or at least a substantial portion of said window is coated with said anti-fog material.

5. The lid for a container as claimed in claim 2, wherein said lid is completely transparent, and is at least partially constructed of said anti-fog material or is at least partially coated with said anti-fog material.

6. The lid for a container as claimed in claim 1, wherein transparent material used to construct said lid, or parts of said lid, is selected from the group consisting of, food grade versions of: PET; PET-A; PET-G; PC;
Polyurethane; Polyvinylchloride; and, Polystyrene.

7. The lid for a container as claimed in claim 1, wherein said lid is constructed of PET-G and/or Styrene.

8. The lid for a container as claimed in claim 1, wherein said anti-fog coating or material is selected from the group consisting of: surfactants coatings; hydrophilic coatings; hydrophilic colloids; and, nanoparticles.

9. The lid for a container as claimed in claim 8, wherein said anti-fog coating or material is SciCron Technologies AF-01 (AF-100™) Permanent Anti-Fog Coating or Hydromer Anti-Fog Coating 2009-68-2.

10. The lid for a container as claimed in claim 2, further including: at least one dispensing nozzle or spout; and/or, at least one vent or hole to assist with anti-fog properties of said lid and/or to allow the aroma of said hot beverage to escape into the surrounding area proximate said cup.

11. The lid for a container as claimed in claim 10, wherein said lid is of the stackable type to aid with the transportation of multiple like cups stacked one on top of another.

12. The lid for a container as claimed in claim 1, comprising a domed portion for reducing or eliminating the build up of condensation on an inner surface of said lid during use.

13. The lid for a container as claimed in claim 12, wherein said domed portion is convex or concave.

14. A method of manufacture of a lid for a container, said method including the steps of: producing a lid having at least one transparent section that enables the contents of said container to be viewed or partially viewed when said lid is fitted to said container; and, applying an anti-fog coating to at least part of said at least one transparent section to prevent build up of condensation on an inner surface of said lid during use.

15. The method of manufacture of a lid for a container as claimed in claim 14, wherein said step of producing said lid includes vacuum forming of said lid from thin sheet/film suitable materials.

16. The method of manufacture of a lid for a container as claimed in claim 14, wherein said lid is for a disposable cup for supplying a hot beverage selected from the group consisting of: coffee, hot chocolate, tea, and, soup.
